(19) United States
(12) Patent Application Publication
(10) Pub. No.: US 2015/0215612 A1
(43) Pub. Date: Jul. 30, 2015

(54) Global Virtual Reality Experience System

(71) Applicant: Ganesh Gopal Masti Jayaram, Hillsboro, OR (US)

(72) Inventor: Ganesh Gopal Masti Jayaram, Hillsboro, OR (US)

(21) Appl. No.: 14/560,690

(22) Filed: Dec. 4, 2014

Related U.S. Application Data
(60) Provisional application No. 61/931,268, filed on Jan. 24, 2014.

(51) Int. Cl. H04N 13/04; G06F 3/01

(52) U.S. Cl. CPC H04N 13/0429; G06F 3/012

(57) ABSTRACT

A virtual reality experience system and method of operation includes a network, a virtual user module, a central data center, and one or more cameras located in various places around the globe. Each of the components are in wireless communication with each other, and are able to communicate via the Internet. The central data center is adapted to store various information relating to the places where cameras are located. The information can be accessed by a user via the virtual user module. In one embodiment, the virtual user module includes a pair of glasses having a three-dimensional display screen that can display live streamed views from the cameras. In other embodiments, a headset is used in conjunction with the glasses. In this way, the user can verbally communicate with others who are located at each location where a camera is positioned.

### CROSS REFERENCE TO RELATED APPLICATION

This application claims the benefit of U.S. Provisional Application No. 61/931,268 filed on Jan. 24, 2014. The above identified patent application is herein incorporated by reference in its entirety to provide continuity of disclosure.

### FIELD OF THE INVENTION

The present invention relates to a system for providing individuals with a global virtual reality experience. More specifically, the present invention pertains to an improved global virtual reality experience system that provides real time video streaming from a physical environment to a virtual user module. In this way, the present invention provides a user with the impression of being physically present in a physical location.

### BACKGROUND OF THE INVENTION

Immersion into virtual reality is a perception of being physically present in a non-physical world. The perception is created by surrounding the user of a virtual reality system in images, sounds, or other stimuli that provide an engrossing total environment. For example, spatial immersion occurs when a person feels the simulated world is perceptually convincing. In other words, the person feels that he or she is really in the simulated world and that the stimulated world looks real. Virtual reality glasses can produce a visceral feeling of being in a simulated world, a form of spatial immersion called presence. The technology requirements to achieve this visceral reaction are generally low-latency and precise tracking movements.

Devices have been disclosed in the prior art that claim virtual reality glasses and similar modules. These include devices that have been patented and published in patent application publications, and generally relate to video game modules. These devices are deemed most relevant to the present disclosure, which are herein described for the purposes of highlighting and differentiating the unique aspects of the present invention, and further highlighting the drawbacks existing in the prior art.

Some prior art devices disclose goggle-like modules that are adapted to be worn on the head, such that the modules completely cover the user's eyes. This prevents the user from viewing his or her surroundings and instead directs the users to a three-dimensional display screen disposed on the interior of the module, creating a sense of visual immersion. The three-dimensional display screen is adapted to display various preprogrammed images or videos in video games. Thus, the images or videos correspond to the video game narrative.

Other modules in the prior art further include speakers for providing audio immersion. Preferably, surround sound acoustics are used. The prior art devices, however, do not communicate with live streaming cameras that are positioned in various locations around the globe. Accordingly, the devices disclosed in the prior art are limited in that they do not allow users to be immersed in a real physical environment in real time. Rather, the prior art devices are adapted to immerse users in a video game environment or other preprogrammed virtual environment.

The present invention overcomes these limitations by disclosing a virtual user module having a three-dimensional display screen that is in communication with a plurality of cameras that are located in various places around the world. The cameras are adapted to provide live streaming views of the place in which it is installed. Thus, the present invention allows a user to view various places around the world in real time. In some embodiments, the virtual user module further comprises a headset that allows the user to receive auditory signals. It is therefore submitted that the present invention is substantially divergent in design elements from the prior art, and consequently it is clear that there is a need in the art for an improvement to virtual reality glasses. In this regard, the instant invention substantially fulfills these needs.

### SUMMARY OF THE INVENTION

In view of the foregoing disadvantages inherent in the known types of virtual reality glasses now present in the prior art, the present invention provides a new and improved global virtual reality experience system wherein the same can be utilized for live streaming video from a place of interest to a virtual user module. The virtual user module is in wireless communication with a network, a central data center, and a plurality of cameras.

Each of the network, the central data center, and the cameras are in wireless communication with each other. The cameras are located in various places around the globe, such as most-visited tourist attractions and popular destinations. The central data center is adapted to store various information regarding the most-visited tourist attractions and popular destinations. In one embodiment, the virtual user module comprises a pair of glasses. The glasses include a three-dimensional display screen that can display live streamed views from the camera. In other embodiments, the virtual user module further comprises a headset that includes speakers and a microphone. In this way, the user can verbally communicate with others who are located at the location where the camera is installed.

It is therefore an object of the invention to provide a new and improved global virtual reality experience system that has all of the advantages of the prior art and none of the disadvantages.

Another object of the present invention is to provide a new and improved global virtual reality experience system that allows the user to verbally communicate with other individuals who are located at a different physical location.

Yet another object of the present invention is to provide a new and improved global virtual reality experience system that provides historic information about various place around the globe.

Still yet another object of the present invention is to provide a new and improved global virtual reality experience system that allows individuals to share their experiences with others.

Still yet another object of the present invention is to provide a new and improved global virtual reality experience system wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a diagram of the global virtual reality experience system of the present invention.

FIG. 2 shows a diagram of the virtual user module in communication with a camera and a centralized data center.

### DETAILED DESCRIPTION OF THE INVENTION

References are made herein to the attached drawings. Like reference numerals are used throughout the drawings to depict like or similar elements of the global virtual reality experience system. For the purposes of presenting a brief and clear description of the present invention, the preferred embodiment will be discussed as used to live stream video from a place of interest to a virtual reality environment. The figures are intended for representative purposes only and should not be considered to be limiting in any respect.

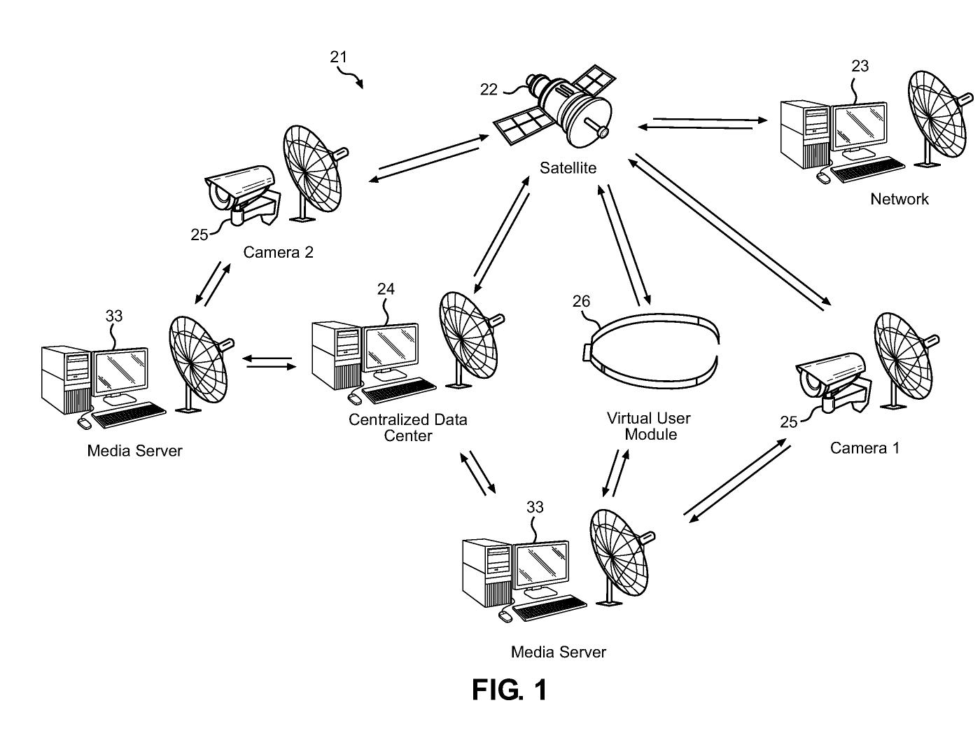

Referring now to FIG. 1, there is shown a diagram of the global virtual reality experience system of the present invention. The present system 21 comprises a high bandwidth content delivery network 23 in communication with one or more satellites 22. The network 23 is in wireless communication with a centralized data center 24 and a plurality of cameras 25, and one or more media servers 33 connected thereto. The media servers 33 are in communication with the centralized data center 24 and a virtual user module 26, which may comprise a pair of glasses and/or a headset worn by a user. The centralized data center 24, the cameras 25, the media servers 33, and the virtual user module 26 are connected to the Internet.

The cameras 25 are located in various locations around the globe. In a preferred embodiment, the cameras 25 comprise professional high definition three-dimensional cameras or Internet protocol cameras that are suitable for outdoor use. Additionally, the cameras 25 are preferably located in most-visited tourist attractions, scenic points, and popular landmarks that many people wish to visit. Each camera 25 is connected to one or more media servers 33, such as a computer that is used as a streaming/encoding machine. It is contemplated that the computer or another streaming/encoding machine comprises a live encoding software that is adapted to provide a live video feed and store the same. The media servers 33 continually receive live streaming video from the cameras 25. Thus, the cameras 25 are adapted to provide clear, multi-bitrate live streaming video of various locations around the globe in real time.

The media servers 33 are in communication with the centralized data center 24, which helps link the virtual user module 26 to the centralized data center 24. The centralized data center 24 is adapted to collect and store data and information relating to places in which the cameras 25 are located. Various systems such as Ethernet networks, such as the Internet, can be used to transfer data and information. Without limitation, the centralized data center 24 can collect historical and well-known information about a particular location, as well as visitor reviews, and information provided by individuals who have previously visited that particular location. It is contemplated that the foregoing information can be input by administrative personnel monitoring and managing the centralized data center 24.

In some embodiments, the centralized data center 24 is also adapted to collect real time information at various locations in which cameras 25 are located, such as weather, traffic, road conditions, and the like. Thus, the cameras 25 may be equipped with various sensors necessary to collect real time information. The sensors can automatically transfer collected data to the centralized data center 24. For instance, the cameras 25 comprise thermometers or temperature sensors to determine the temperature of the location in which the cameras 25 are installed. The information collected and stored in the centralized data center 24 can be directly accessed via the virtual user module 26. Alternatively, the information collected and stored in the centralized data center 24 can be accessible through the media servers 33. The media servers 33 is adapted to selectively retrieve information pertaining to a place in which a particular camera 25 connected thereto is located. Thus, the media servers 33 can help sort and organize the information stored in the centralized data center 24. It is contemplated that the information collected and stored in the centralized data center 24 can be delivered audibly or visually.

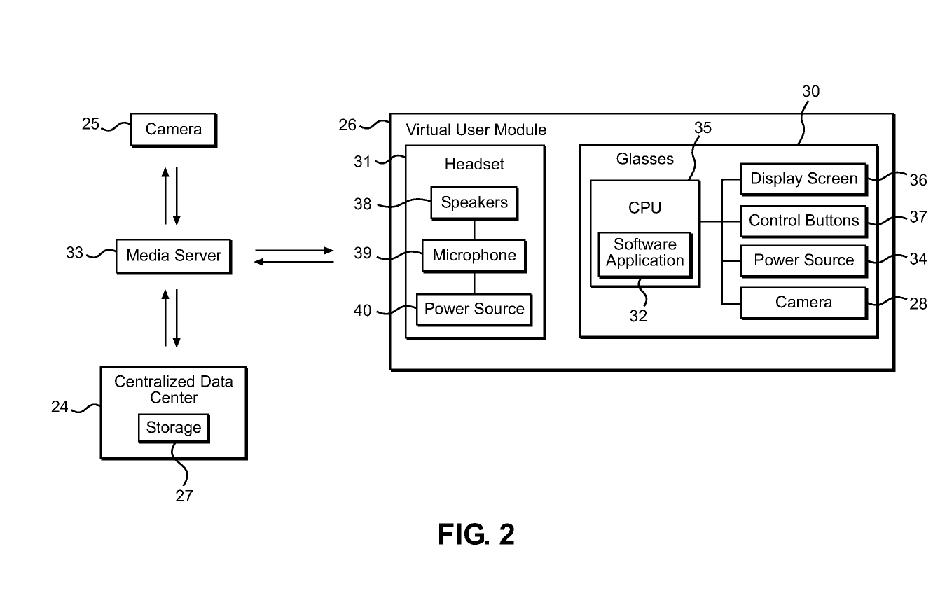

Referring now to FIG. 2, there is shown an exemplary diagram of the virtual user module in wireless communication with a camera and a centralized data center. In one embodiment, the virtual user module 26 comprises a pair of glasses 30. In other embodiments, the virtual user module 26 further comprises a headset 31 that can be used with the glasses 30. The glasses 30 comprise a display screen 36 in electrical connection with a video player, and one or more control buttons 37. The display screen 36 is adapted to toggle between augmented reality view and total immersion.

Preferably, the display screen 36 comprises a three-dimensional display screen so as to increase visual immersion and improve user experience. Without limitation, the display screen 36 is adapted to provide a wide field of view (approximately 80 degrees or greater), resolution 1080p or better, pixel persistence of 3 ms or less, a refresh rate of 60 Hz to 95 Hz, latency of 20 ms motion to last photon, and optical calibration. Additionally, the display screen 36 comprises a global display where all pixels are illuminated simultaneously.

The control buttons 37 are used to select or change a camera's live stream. The control buttons 37 are electrically connected to a CPU 35, which comprises a software application 32 that enables the virtual user module 26 to be linked to a media server 33 that is connected to a particular camera 25. The software application 32 allows the CPU 35 to identify the camera 25 that provides the selected live stream. In one embodiment, the CPU 35 can identify cameras 25 by associating each camera with a global positioning system coordinate. Thereafter, the glasses 30 connect with the media server 33 that is connected to the respective camera 25. The media server 33 then broadcasts the live image so that the user can view the live streaming video being captured by that particular camera 25.

Alternatively, the control buttons 37 are used to access information stored in the centralized data center 24. The centralized data center 24 comprises computers having long term storage medium 27 for storing information relating to the location of the cameras 25. The software application further enables the CPU 35 to select information that correlates to the location of the live streaming video being captured by a camera 25. In another embodiment, the control buttons 37 can trigger the media server 33 to retrieve information from the centralized data center 24. The information can be delivered visually via the display screen 36 of the glasses 30, or audibly via the headset 31.

In some embodiments, the virtual user module 26 further comprises a headset 31. The headset 31 includes a speaker 38 and a microphone 39. The headset 31 can be used in conjunction with the glasses 30. The speakers 38 allow the user to listen to the sounds from the location of the camera's live stream. Additionally, the microphone 39 allows the user to send audible messages to the location of the camera's live stream. Thus, the camera 25 is equipped with a speaker and a microphone. In this way, the headset 31 allows the user to verbally communicate with another individual who is physically present at the location of the camera's live stream. It is contemplated that the electrical components of the glasses are powered internally via a power source 34, 40 such as batteries.

In yet another embodiment, the glasses 30 further comprise a side mounted camera 28 or a built-in camera. The side mounted camera 28 is actuated via one or more of the control buttons 37. The side mounted camera 28 is connected to the Internet to allow the user to capture live images of the user's surroundings to send the captured images to other individuals. The live images of the user's surroundings may be accessible via another virtual user module 26 or other electronic devices having Internet access. Thus, the present invention provides means for users to visually communicate with others.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A global virtual reality experience system, comprising:
a plurality of cameras located in different locations around the globe to provide a live streaming video;
a centralized data center having a storage medium for collecting and storing information relating to different locations in which said plurality of cameras is located;
each of said plurality of cameras and said centralized data center connected to one or more media servers;
said one or more media servers adapted to continuously receive said live streaming video and selectively retrieve said information relating to different locations in which said plurality of cameras is located;
a virtual user module adapted to provide visual immersion to a user;
said virtual user module in wireless communication with said one or more media servers to retrieve said live streaming video being captured by said plurality of cameras and information relating to different locations in which said plurality of cameras is located;
each of said plurality of cameras, said one or more media servers, said centralized data center, and said virtual user module in wireless communication with a network.

2. The global virtual reality experience system of claim 1, wherein said virtual user module comprises a pair of glasses having a three-dimensional display screen adapted to display said live streaming video.

3. The global virtual reality experience system of claim 2, further comprising a headset having a speaker and a microphone.

4. The global virtual reality experience system of claim 2, wherein said pair of glasses further comprise a side mounted camera for capturing live images of the surroundings of said user.

5. The global virtual reality experience system of claim 2, wherein said virtual user module further comprises a central processing unit having a software application that enables said virtual user module to be linked to said one or more media servers.

6. The global virtual reality experience system of claim 1, wherein said virtual user module comprises at least one control button for selecting said live streaming video.

7. The global virtual reality experience system of claim 1, wherein said virtual user module comprises at least one control button for selecting information relating to different locations in which said plurality of cameras is located.

8. The global virtual reality experience system of claim 1, wherein said one or more media servers comprises a live encoding software that is adapted to provide a live video feed.
